(19) United States
(12) Patent Application Publication
(10) Pub. No.: US 2023/0244792 A1
(43) Pub. Date: Aug. 3, 2023

(54) METHOD FOR PROTECTING AGAINST THE THEFT OF MACHINE LEARNING MODULES, AND PROTECTION SYSTEM

(71) Applicant: Siemens Aktiengesellschaft, Munchen (DE)

(72) Inventors: Anja von Beuningen, Erfurt (DE); Michel Tokic, Tettnang (DE); Boris Scharinger, Fürth (DE)

(21) Appl. No.: 18/099,167

(22) Filed: Jan. 19, 2023

(30) Foreign Application Priority Data
Feb. 3, 2022 (EP) 22155036.1

(51) Int. Cl. G06F 21/57; G06F 21/62; G06N 3/091

(52) U.S. Cl. CPC G06F 21/577; G06F 21/6218; G06N 3/091; G06F 2221/032

(57) ABSTRACT

To protect against the theft of a machine learning module predicting sensor signals, the machine learning module is trained, on the basis of a timeseries of a sensor signal, to predict a later signal value of the sensor signal as first output signal and to output a scatter width of the predicted later signal value as second output signal. The machine learning module is expanded, and the expanded machine learning module is transferred to a user. When an input signal is supplied, a first and a second output signal are derived from the input signal. The checking module then checks whether a later signal value of the input signal lies outside a scatter width indicated by the second output signal by a signal value indicated by the first output signal. An alarm signal is output depending on the check result, if later signal values lie outside the scatter width.

### CROSS-REFERENCE TO RELATED APPLICATIONS

This application claims priority to EP Application No.22155036.1, having a filing date of Feb. 3, 2022, the entire contents of which are hereby incorporated by reference.

### FIELD OF TECHNOLOGY

The following relates to a method for protecting against the theft of machine learning modules, and protection system.

### BACKGROUND

Complex machines, such as for example robots, motors, manufacturing installations, machine tools, gas turbines, wind turbines or motor vehicles generally require complex control and monitoring methods for productive and stable operation. For this purpose, machine learning techniques are often used in modern machine controllers. A neural network as control model may thus for example be trained to control a machine in an optimized manner.

Training neural networks or other machine learning modules to control complex machines however often turns out to be highly burdensome. Large amounts of training data, considerable computing resources and a great deal of specific expert knowledge are thus generally required. There is therefore great interest in protecting trained machine learning modules or training information contained therein against uncontrolled or unauthorized distribution or use and/or in protecting same against theft.

It is known, in order to recognize theft of neural networks, to provide their neural weights with a unique digital watermark before they are put into service. The watermark may then be used to check an existing neural network as to whether it originates from the user of the watermark. However, such methods offer only little protection against what is known as model extraction, in which a potentially marked neural network is used to train a new machine learning module to behave in a manner similar to the neural network. A watermark applied to neural weights is in this case generally no longer able to be verified reliably in the newly trained machine learning module.

The Internet document https://www.internet-sicherheit.de/research/cybersicherheitund-kuenstliche-intelligenz/model-extraction-attack.html (retrieved on Dec. 16, 2021) discusses several methods for protecting against model extraction and the problems with said methods.

### SUMMARY

An aspect relates to specify a method for protecting against the theft of a machine learning module and a corresponding protection system that offer better protection against model extraction.

According to embodiments of the invention, in order to protect against the theft of a machine learning module intended to predict sensor signals, said machine learning module is trained, on the basis of a timeseries of a sensor signal, to predict a later signal value of the sensor signal as first output signal and to output a scatter width of the predicted later signal value as second output signal. The machine learning module is furthermore expanded with a checking module, and the expanded machine learning module is transferred to a user. When an input signal is supplied to the transferred machine learning module, a first output signal and a second output signal are derived from the input signal. According to embodiments of the invention, the checking module then checks whether a later signal value of the input signal lies outside a scatter width indicated by the second output signal by a signal value indicated by the first output signal. Finally, an alarm signal is output depending on the check result, in particular in the event of one or more later signal values lying outside the scatter width.

In order to perform the method according to embodiments of the invention, provision is made for a protection system, a computer program product (non-transitory computer readable storage medium having instructions, which when executed by a processor, perform actions) and a computer-readable, non-volatile storage medium.

The method according to embodiments of the invention and the protection system according to embodiments of the invention may be executed or implemented for example by way of one or more computers, processors, application-specific integrated circuits (ASIC), digital signal processors (DSP) and/or what are known as “field-programmable gate arrays” (FPGA). The method according to embodiments of the invention may furthermore be executed at least partially in a cloud and/or in an edge computing environment.

In many cases, embodiments of the invention offers efficient and comparatively reliable protection for machine learning modules against unauthorized model extraction. The method is based on the observation that, in a model extraction attempt, a representation space of the input signals of the machine learning module is generally sampled systematically and/or on a random basis. However, the input signals sampled in this way generally have no temporal dependency or a temporal dependency different from the sensor signals used for training. It may thus be assessed to be an indicator of model extraction when the predictions of the trained machine learning module are not compatible with a temporal characteristic of the input signals. Embodiments of the invention may furthermore be applied in a flexible manner and is in particular not limited to artificial neural networks.

According to one advantageous embodiment of the invention, the machine learning module may be trained to use the scatter width output as second output signal to reproduce an actual scatter width of the actual later signal value of the sensor signal.

For this purpose, during training, a log likelihood error function of the scatter width may in particular be used as cost function or reward function. Such a log likelihood error function is often also called a logarithmic plausibility function. The log likelihood error function may be used to estimate a distance between the scatter width output as second output signal and an actual scatter width. It is thus possible to optimize parameters to be trained, for example neural weights of the machine learning module, such that the distance is minimized or at least reduced.

As an alternative or in addition, the machine learning module may comprise a Bayesian neural network that is trained to reproduce the actual scatter width of the actual later signal value of the sensor signal. Efficient numerical methods are available for training a Bayesian neural network, these giving the Bayesian neural network the ability to derive predictions, together with their scatter widths, from the input signals. Relevant training methods are described for example in the publication “Pattern Recognition and Machine Learning” by Christopher M. Bishop, Springer 2011.

According to one advantageous development of embodiments of the invention, provision may be made for a control agent for controlling a machine, which control agent generates a control signal for controlling the machine on the basis of a sensor signal from the machine. The control signal generated by the control agent on the basis of the sensor signal from the machine may then be taken into consideration when training the machine learning module. Furthermore, the input signal may be supplied to the control agent and the control signal generated by the control agent on the basis of the input signal may be supplied to the transferred machine learning module. The first output signal and the second output signal from the transferred machine learning module may then be generated on the basis of the control signal. Control actions of the control agent may thereby be incorporated into the prediction of sensor signals and the scatter widths thereof, both during training and during the evaluation of the machine learning module. A learning-based control agent may be used as control agent, this being trained, in particular by way of a reinforcement learning method, to generate an optimized control signal on the basis of a sensor signal from the machine.

According to a further advantageous embodiment of the invention, the check may be performed by the checking module for a multiplicity of later signal values of the input signal. A number and/or a proportion of later signal values lying outside the scatter width respectively indicated by the second output signal may be determined here. The alarm signal may then be output on the basis of the determined number and/or the determined proportion. As an alternative or in addition, it is possible to determine, for a respective later signal value of the input signal, the exceedance factor by which its distance from the signal value indicated by the first output signal exceeds the scatter width indicated by the second output signal. The alarm signal may then be output on the basis of one or more of the determined exceedance factors. The alarm signal may in particular be output if the number, the proportion and/or one or more of the exceedance factors exceed a respectively predefined threshold value.

According to a further advantageous embodiment of the invention, the machine learning module, the checking module and possibly a control agent may be encapsulated in a software container, in particular in a key-protected or signature-protected software container. The software container may be configured such that the machine learning module, the checking module and/or possibly the control agent lose their function in the event of the software container being taken apart.

### BRIEF DESCRIPTION

Some of the embodiments will be described in detail, with reference to the following figures, wherein like designations denote like members, wherein:

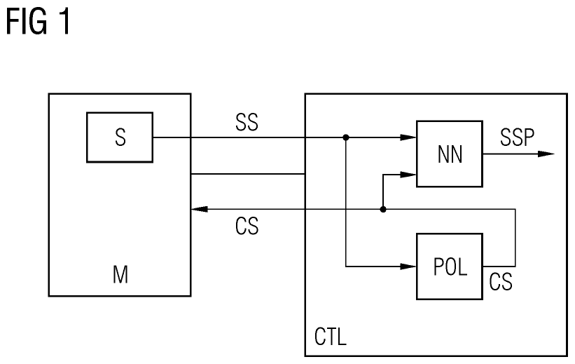

FIG. 1 shows the control of a technical system by way of a learning-based control device;

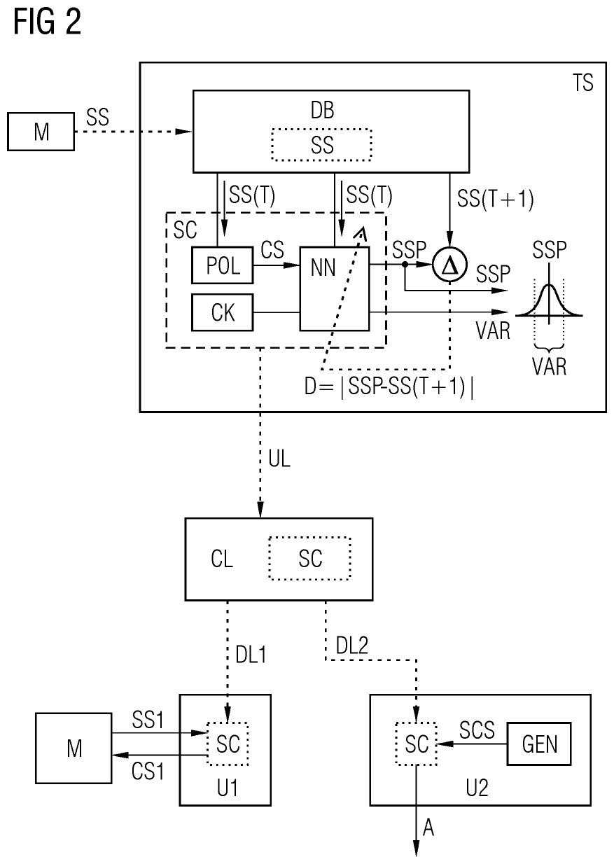

FIG. 2 shows a protection system for machine learning modules according to an embodiment of the invention; and

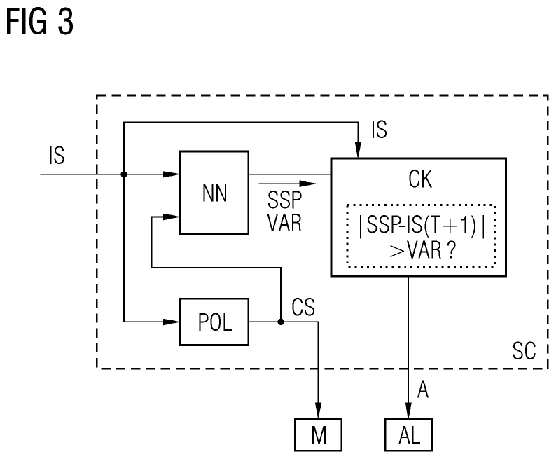

FIG. 3 shows the operation of a machine learning module protected according to an embodiment of the invention.

### DETAILED DESCRIPTION

Where the same or corresponding reference signs are used in the figures, these reference signs denote the same or corresponding entities, which may in particular be implemented or embodied as described in connection with the figure in question.

FIG. 1 schematically shows the control of a technical system M by way of a learning-based control device CTL. The technical system M may in this case in particular be a machine, a robot, a motor, a manufacturing installation, a machine tool, a traffic control system, a turbine, an internal combustion engine and/or a motor vehicle or comprise such a system.

The control device CTL may in particular be intended to predict probable malfunctions or failures of the technical system M and/or to predict air quality values.

It is assumed for the present exemplary embodiment that the technical system M is a machine, for example a manufacturing robot. The control device CTL is accordingly designed as a machine controller.

The machine controller CTL is coupled to the machine M. FIG. 1 illustrates the machine controller CTL outside the machine M. As an alternative thereto, the machine controller CTL may however also be integrated fully or partially into the machine M.

The machine M has a sensor system S that continuously measures operating parameters of the machine M and other measured values, for example from an environment of the machine M. The measured values determined by the sensor system S are transferred from the machine M to the machine controller CTL in the form of time-resolved sensor signals SS.

The sensor signals SS quantify an operating state of the machine M or an operating state of one or more of the components thereof over time. The sensor signals SS may in particular quantify a power output, a rotational speed, a torque, a movement speed, an exerted or acting force, a temperature, a pressure, current resource consumption, available resources, exhaust emissions, vibrations, wear and/or loading of the machine M or of components of the machine M. The sensor signals SS are each represented by a timeseries of signal values or by a timeseries of numerical data vectors and transferred to the machine controller CTL in this form.

For the sake of clarity, only a single sensor signal SS will be considered below, but this is also intended to represent the case encompassing multiple sensor signals SS.

The machine controller CTL has a learning-based control agent POL for controlling the machine M. The control agent POL is trained to output an optimized control signal CS for controlling the machine M on the basis of a sensor signal SS from the machine M. The control signal CS is optimized such that the machine M is controlled in an optimum manner in the operating state specified by the supplied sensor signal SS. Such a control agent POL is often also called a policy. Many efficient machine learning methods are available for the training thereof, in particular reinforcement learning methods.

The machine controller CTL furthermore has a machine learning module NN for predicting the sensor signal SS. The machine learning module NN is trained on the basis of signal values of the sensor signal SS that are present up to a time T and on the basis of the control signal CS output by the control agent POL, to predict at least one signal value SSP of the sensor signal SS for at least one time following the time T. The training of the machine learning module NN will be discussed in even more detail below.

The machine learning module NN and/or the control agent POL may in particular be implemented as artificial neural networks. As an alternative or in addition, the machine learning module NN and/or the control agent POL may comprise a recurrent neural network, a convolutional neural network, a perceptron, a Bayesian neural network, an autoencoder, a variational autoencoder, a Gaussian process, a deep learning architecture, a support vector machine, a data-driven regression model, a k-nearest neighbour classifier, a physical model and/or a decision tree.

In order to control the machine M, its sensor signal SS is supplied, as input signal, to an input layer of the trained control agent POL and to an input layer of the trained machine learning module NN. The control agent POL uses the sensor signal SS to generate the control signal CS as output signal. The control signal CS or a signal derived therefrom is finally transmitted to the machine M in order to control it in an optimized manner. The control signal CS is furthermore supplied to the machine learning module NN as further input signal. The machine learning module NN derives at least one future signal value SSP of the sensor signal SS from the sensor signal SS and the control signal CS. The at least one future signal value SSP may optionally be supplied to the control agent POL in order thereby to generate a predictively optimized control signal CS. The at least one later signal value SSP is however furthermore used, according to embodiments of the invention—as explained further below—to detect model extraction.

FIG. 2 shows a protection system for machine learning modules according to embodiments of the invention. In the present exemplary embodiment, the intention is to protect not only the machine learning module NN but also the learning-based control agent POL as further machine learning module using the protection system.

It is assumed that the control agent POL to be protected has, as described above, already been trained by way of a reinforcement learning method to output, on the basis of a sensor signal SS from the machine M, a control signal CS by way of which the machine M is able to be controlled in an optimized manner. Instead of or in addition to the learning-based control agent POL, provision may also be made for a rule-based control agent. The control agent POL is coupled to the machine learning module NN.

The machine learning module NN to be protected is trained, in a training system TS, on the basis of a timeseries of the sensor signal SS from the machine M, both to predict a later signal value of the sensor signal SS as first output signal SSP and to output a scatter width of the predicted later signal value as second output signal VAR.

The training is carried out on the basis of a large set of timeseries of the sensor signal SS, which function as training data. The training data originate from the machine M to be controlled, from a machine similar thereto and/or from a simulation of the machine M. In the present exemplary embodiment, the training data originate from the machine M and are stored in a database DB of the training system TS.

The signal values of a timeseries of the sensor signal SS up to a respective time T are called SS(T) below. A signal value of this timeseries at a time T+1 later than the respective time T is accordingly denoted SS(T+1). The designation T+1 here not only represents a time immediately following the time T in the timeseries, but may also denote any time later than T.

Training is understood to mean in general optimization of mapping of an input signal of a machine learning module onto its output signal. This mapping is optimized during a training phase in accordance with predefined criteria. A prediction error may be applied as criterion in particular in the case of prediction models such as the machine learning module NN, and success of a control action may be applied as criterion in the case of control models such as the learning-based control agent POL. The training may for example be used to set or optimize network structures of neurons of a neural network and/or weights of connections between the neurons such that the predefined criteria are met as well as possible. The training may thus be understood as an optimization problem.

Many efficient optimization methods are available for such optimization problems in the field of machine learning, in particular gradient-based optimization methods, gradient-free optimization methods, backpropagation methods, particle swarm optimizations, genetic optimization methods and/or population-based optimization methods. It is possible to train in particular artificial neural networks, recurrent neural networks, convolutional neural networks, perceptrons, Bayesian neural networks, autoencoders, variational autoencoders, Gaussian processes, deep learning architectures, support vector machines, data-driven regression models, k-nearest neighbor classifiers, physical models and/or decision trees.

In order to train the machine learning module NN, the timeseries of the sensor signal SS that are contained in the training data are fed to the machine learning module NN and to the control agent POL as input signals. In the process, the control agent POL generates a control signal CS on the basis of the signal values SS(T) present up to a respective time T—as described above. The control signal CS is supplied by the control agent POL to the machine learning module NN as additional input signal.

The machine learning module NN generates a first output signal SSP and a second output signal VAR from the signal values SS(T) present up to a respective time T and the control signal CS. In the course of training, neural weights or other parameters of the machine learning module NN are then set using one of the optimization methods mentioned above such that a respective later signal value SS(T+1) of the sensor signal SS is reproduced as accurately as possible by the first output signal SSP and a statistical scatter width of the first output signal SSP is reproduced as accurately as possible by the second output signal VAR.

For this purpose, in the present exemplary embodiment, the first output signal SSP is compared with the respective later signal value SS(T+1), and a respective distance D between these signals is determined. As distance D, it is possible to determine for example a Euclidean distance between the respectively representative data vectors or another norm of their difference, for example in accordance with D=|SSP−SS(T+1)|or D=(SSP-SS(T+1))2.

The second output signal VAR is furthermore compared with a statistical scatter width of the first output signal SSP and/or of the respective later signal value SS(T+1). The scatter width may in this case in particular be represented by a statistical scatter, a statistical variance or a probability distribution. The comparison is carried out by way of a negative log likelihood error function that is used as cost function, together with the distance D, to train the machine learning module NN.

For this purpose, the determined distances D and the values of the cost function are fed back to the machine learning module NN. The neural weights thereof are then set such that the distance D and the cost function, for example as a weighted combination, are minimized at least on statistical average.

The training gives the machine learning module NN the ability to predict a respective future signal value, here SS(T+1), of the sensor signal SS and its respective scatter width. The first output signal SSP thus represents a respective predicted signal value of the sensor signal SS and the second output signal VAR represents its respective scatter width.

As an alternative or in addition, the machine learning module NN may also comprise a Bayesian neural network. A Bayesian neural network may be used as a statistical estimator that determines, in parallel with and intrinsically with respect to a respective predicted signal value, its scatter width. Implementation variants of such Bayesian neural networks may be taken for example from the abovementioned publication “Pattern Recognition and Machine Learning” by Christopher M. Bishop, Springer 2011.

Signal values SSP and scatter widths VAR predicted by the machine learning module NN are intended to be used to check, during later use of the machine learning module NN or of the control agent POL, whether the input signals fed to the machine learning module NN have time dependencies similar to the sensor signal SS. In the event of similar time dependencies, it should be expected that the predictions of the machine learning module NN do not differ significantly in terms of the respective scatter width from the actual later signal values of the input signals.

Similar time dependencies of the input signals represent correct operation of the machine learning module NN or of the control agent POL. By contrast, a significant deviation in the time dependencies is a pointer to systematic or randomly controlled sampling of the machine learning module NN or of the control agent POL and thus a strong indicator of a model extraction attempt.

Following training, the machine learning module NN is expanded with a checking module CK by the training system TS. The checking module CK is in this case coupled to the machine learning module. In order to protect the interfaces of the machine learning module to the checking module CK and to the control agent POL against unauthorized access, the trained machine learning module NN is encapsulated in a software container SC together with the checking module CK and the control agent POL by the training system TS. The encapsulation takes place in a key-protected and/or signature-protected manner. The encapsulated interfaces may in this case be protected for example through encryption or obfuscation. The software container SC is embodied such that the machine learning module NN, the control agent POL and/or the checking module CL lose their function in the event of the software container SC being taken apart.

The software container SC protected in this way may then be passed on to users. For this purpose, the software container SC is transferred by the training system TS to a cloud CL, in particular to an app store in the cloud CL, through an upload UL.

In the present exemplary embodiment, the software container SC is downloaded from the cloud CL or its app store through a first download DL1 to a system U1 of a first user, on the one hand, and through a second download DL2 to a system U2 of a second user, on the other hand.

It is assumed for the present exemplary embodiment that the first user wishes to control the machine M as intended using the protected control agent POL and the machine learning module NN on his system U1. On the other hand, the second user wishes to perform unauthorized model extraction on the trained control agent POL and/or on the trained machine learning module NN on his system U2.

The system U1 receives a sensor signal SS1 from the machine M in order to control the machine M and supplies it to the software container SC as input signal. In the software container SC, the checking module CK checks whether the predictions of the machine learning module NN deviate significantly in terms of the respective scatter width from the actual later signal values of the input signal SS1. A run-through of the check is explained in more detail below.

When, in the present exemplary embodiment, the sensor signal SS1 along with the sensor signal SS used for training originate from the machine M, it should be expected that the sensor signals SS1 and SS will have similar time dependencies. Accordingly, the checking module CK detects no significant deviation in the predictions of the machine learning module NN in the system U1, this representing correct normal operation of the machine learning module NN and of the control agent POL. As a result, the machine M is able to be controlled by a control signal CS1 from the trained control agent POL, as desired by the user.

Unlike in the case of the first user, in the system U2 of the second user, a generator GEN generates a synthetic sampling signal SCS as input signal for the software container SC in order to systematically sample the machine learning module and/or the control agent POL. The input signal SCS fed to the software container SC, as described above, is checked by the checking module CK to determine whether the predictions of the machine learning module NN deviate significantly from the actual later signal values of the input signal SCS.

When such sampling signals generally do not have the same time dependencies as the sensor signal SS used for training, it may be assumed that a statistically significant proportion of the later signal values of the sampling signal SS lie outside the respective scatter width by more than a respective prediction value of the machine learning module NN. In the present exemplary embodiment, this is recognized by the checking module CK and assessed as an indicator of unauthorized model extraction. As a result, the checking module CK transmits an alarm signal A for example to a creator of the trained machine learning module NN and/or of the control agent POL. The alarm signal A may inform the creator of the trained machine learning module NN and/or of the control agent POL about the model extraction attempt.

FIG. 3 shows the operation of a machine learning module NN or of a control agent POL protected according to embodiments of the invention. The machine learning module NN and the control agent POL, as already mentioned above, are encapsulated in a software container SC together with the checking module CK. The machine learning module NN is in this case coupled to the control agent POL and to the checking module CK via interfaces that are protected against unauthorized access.

During operation, either a sensor signal SS1 from the machine M or a synthetic sampling signal SCS is fed to the software container SC, according to the present exemplary embodiment, as input signal IS. As mentioned above, it is assumed here that the sensor signal SS1 is fed as part of the intended use of the software container SC, while the sampling signal SCS is supplied in the event of attempted model extraction.

The input signal IS is supplied to the machine learning module NN, to the control agent POL and to the checking module CK. The control agent POL uses the input signal IS, as explained above, to generate a control signal CS, which is in turn supplied to the machine learning module NN as additional input signal. The machine learning module NN, as described above, derives a first output signal SSP and a second output signal VAR from the control signal CS and the input signal IS and transmits the output signals SSP and VAR to the checking module CK.

The checking module CK checks, on the basis of the output signals SSP and VAR and on the basis of signal values IS(T) of the input signal IS that are present up to a respective time T, whether a respective later signal value IS(T+1) of the input signal IS deviates significantly from the predictions of the machine learning module NN.

For this purpose, the checking module CK determines a distance between a respective predicted signal value indicated by the first output signal SSP and a respective later signal value IS(T+1). This respective distance is compared with a respective scatter width indicated by the second output signal VAR. If in the process a respective distance exceeds a respective scatter width, this is assessed by the checking module CK as a deviation from the prediction of the machine learning module NN. If, finally, a statistically significant proportion or a statistically significant number of the later signal values IS(T+1) deviate from the predictions of the machine learning module NN, this is assessed as an indicator of unauthorized model extraction. In this case, the checking module CK generates an alarm signal A. Otherwise, correct normal operation is diagnosed by the checking module CK.

As already mentioned above, it should be expected that the sensor signal SS1 originating from the machine M will have time dependencies similar to the timeseries of the sensor signal SS used to train the machine learning module NN. The checking module CK will in this case accordingly detect no significant deviations in the predictions of the machine learning module NN and indicate normal operation of the software container SC. As a result, the control signal CS for controlling the machine M is output.

In contrast thereto, when the sampling signal SCS is supplied, it may be assumed that significant deviations in the predictions of the machine learning module NN occur. As a result, the checking module CK outputs the alarm signal A for example to an alarm AL of a creator of the machine learning module NN and/or of the control agent POL.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for protecting against the theft of a machine learning module intended to predict sensor signals, wherein
a) the machine learning module is trained, on the basis of a timeseries of a sensor signal, to predict a later signal value of the sensor signal as first output signal and to output a scatter width of the predicted later signal value as second output signal,
b) the machine learning module is expanded with a checking module,
c) the expanded machine learning module is transferred to a user,
d) an input signal is supplied to the transferred machine learning module,
e) a first output signal and a second output signal are derived from the input signal by the transferred machine learning module,
f) the checking module checks whether a later signal value of the input signal lies outside a scatter width indicated by the second output signal by a signal value indicated by the first output signal, and
g) an alarm signal is output depending on the check result.

2. The method as claimed in claim 1, wherein
the machine learning module is trained to use the scatter width output as second output signal to reproduce an actual scatter width of the actual later signal value of the sensor signal.

3. The method as claimed in claim 2, wherein, during training, a log likelihood error function of the scatter width is used as cost function in order to reproduce the actual scatter width of the actual later signal value of the sensor signal.

4. The method as claimed in claim 2, wherein the machine learning module comprises a Bayesian neural network that is trained to reproduce the actual scatter width of the actual later signal value of the sensor signal.

5. The method as claimed in claim 1, wherein provision is made for a control agent for controlling a machine, which control agent generates a control signal for controlling the machine on the basis of a sensor signal from the machine,
wherein the control signal generated by the control agent on the basis of the sensor signal from the machine is taken into consideration when training the machine learning module,
wherein the input signal is supplied to the control agent,
wherein the control signal generated by the control agent on the basis of the input signal is supplied to the transferred machine learning module, and
wherein the first output signal and the second output signal from the transferred machine learning module are generated on the basis of the control signal.

6. The method as claimed in claim 1, wherein the check is performed by the checking module for a multiplicity of later signal values of the input signal,
in that a number and/or a proportion of later signal values lying outside the scatter width respectively indicated by the second output signal is determined, and
in that the alarm signal is output on the basis of the determined number and/or the determined proportion.

7. The method as claimed in claim 1, wherein the machine learning module and the checking module are encapsulated in a software container.

8. A protection system for protecting against the theft of a machine learning module intended to predict sensor signals, configured to carry out all the method steps of the method as claimed in claim 1.

9. A computer program product, comprising a computer readable hardware storage device having computer readable program code stored therein, said program code executable by a processor of a computer system to implement a method configured to execute the method as claimed in claim 1.

10. A computer-readable storage medium containing the computer program product as claimed in claim 9.
